(19) United States
(12) Patent Application Publication
(10) Pub. No.: US 2023/0064220 A1
(43) Pub. Date: Mar. 2, 2023

(54) Configurable Inductor for Broadband Electronic Systems

(71) Applicant: Abdellatif El Moznine, Cupertino, CA (US)

(72) Inventor: Abdellatif El Moznine, Cupertino, CA (US)

(21) Appl. No.: 17/897,141

(22) Filed: Aug. 27, 2022

Related U.S. Application Data
(60) Provisional application No. 63/237,903, filed on Aug. 27, 2021.

(51) Int. Cl. H01F 29/02

(52) U.S. Cl. CPC H01F 29/02

(57) ABSTRACT

A configurable inductor comprises a primary conductor loop uninterrupted by any switches. Inside the primary conductor are one or more secondary conductor loops, each with a switch that allows interrupting the secondary conductor loop. Multiple secondary conductor loops may be electrically coupled to form combined secondary conductor loops. The primary conductor loop may span multiple interconnect layers. A secondary conductor loop may span multiple interconnect layers, and the number of interconnect layers may be configurable by additional switches. There may also be one or more tertiary conductor loops partially outside the primary conductor loop. And there may be quaternary conductor loops on different interconnect layers than the primary conductor loop.

### CROSS REFERENCES

This application claims priority from U.S. provisional patent application Ser. No. 63/237,903, entitled Configurable Inductor for Broadband RF Systems filed on 27 Aug. 2021, which is hereby incorporated by reference as if set forth in full in this application for all purposes.

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to inductor devices and electrical resistors, and in particular to inductor devices used in radio-frequency (RF) circuits.

### Context

Broadband RF systems, such as radio transmitters and receivers, and wireline communication systems, use inductors in critical circuits such as oscillators, filters and bandwidth extension circuits. Inductors, along with capacitors, are devices that store electromagnetic energy, whereas resistors convert electric energy and radiate the converted energy as heat, light, or other electromagnetic waves. Practical devices don't have ideal behavior, and may along with their intended behavior (inductance, capacitance, or resistance) show some parasitic behavior.

### SUMMARY

Integrated circuit (IC) designs often include radios and other communication circuits. Those radio and other circuits may include one or more inductors, composed of metal loops using the aluminum or copper in the available interconnect layers. Likewise, PCB designs may include inductors directly using the available interconnect layers. Broadband RF systems, such as radio transmitters and receivers, and wireline communication systems, use inductors in critical circuits such as oscillators, filters and bandwidth extension circuits. However, on-chip inductors with a high quality factor Q are narrowband, so that high-quality broadband applications such as radios and phase-locked loops may need multiple inductors. Tunable or configurable inductors have not offered a solution, as their quality factor Q is generally low. Implementations of the disclosed technology solve this problem, providing a high Q factor as well as tunability.

In a first aspect, an implementation provides a configurable inductor with a primary conductor loop and one or more secondary conductor loops inside the primary conductor loop. The primary conductor loop is an open loop uninterrupted by any switches, and ending in inductor terminals. Secondary conductor loops are closed loops that are interrupted by a digitally controlled switch. The secondary conductor loops are inductively coupled with the primary conductor loop. In some implementations, a secondary conductor loop is electrically coupled with the primary conductor loop via a single bridge. The primary conductor loop and the secondary conductor loop(s) may use one or more interconnect layers (of the IC or of the PCB or substrate).

The configurable inductor may further comprise tertiary conductor loops, which are arranged at least partially outside the primary conductor loop. It may also comprise quaternary conductor loops arranged at least partially on a different interconnect layer than the primary conductor loop.

In a second aspect, an implementation provides a configurable inductor with a primary conductor loop and one or more tertiary conductor loops.

In a third aspect, an implementation provides a configurable inductor with a primary conductor loop and one or more quaternary conductor loops.

A further understanding of the nature and the advantages of particular implementations disclosed herein may be realized by reference of the remaining portions of this specification and the attached drawings.

### BRIEF DESCRIPTION OF THE DRAWINGS

This patent document or its application file contains one or more color drawings. The U.S. Patent and Trademark Office (USPTO) will provide a copy of this patent or patent application publication with color drawings upon request and payment of required fees. The color drawings also may be available at patentcenter.uspto.gov for this patent application via the Supplemental Content tab.

The invention will be described with reference to the drawings, in which:

FIG. 1 illustrates a configurable inductor in an implementation of the disclosed technology.

FIG. 2 illustrates another configurable inductor in an implementation of the disclosed technology.

FIG. 3 provides a table showing example inductance values achieved with different settings of the digitally controlled switches in FIG. 1.

FIG. 4 illustrates inductance values of the inductor in FIG. 1 as a function of the frequency.

FIG. 5 illustrates another example configurable inductor.

FIG. 6 illustrates an example configurable differential inductor.

FIG. 7 illustrates an example configurable inductor with primary, secondary and tertiary conductor loops.

In the figures, like reference numbers may indicate functionally similar elements. The systems and methods illustrated in the figures, and described in the Detailed Description below, may be arranged and designed in a wide variety of different implementations. Neither the figures, nor the Detailed Description, are intended to limit the scope as claimed. Instead, they merely represent examples of different implementations of the technology.

### DETAILED DESCRIPTION

Integrated circuit designs often include radios and other communication circuits. Those radio and other circuits may include one or more inductors, composed of metal loops using the aluminum or copper in the available interconnect layers. Likewise, PCB designs may include inductors directly using the available interconnect layers. Broadband RF systems, such as radio transmitters and receivers, and wireline communication systems, use inductors in critical circuits such as oscillators, filters and bandwidth extension circuits. Inductors, along with capacitors, are devices that store electromagnetic energy, whereas resistors convert electric energy and radiate the converted energy as heat, light, or other electromagnetic waves. Practical devices don't have ideal behavior, and may along with their intended behavior (inductance, capacitance, or resistance) show some parasitic behavior. For example, an inductor or a capacitor may show some parasitic resistance, causing a partial loss of the energy that is stored. In case of a tuned circuit that has an inductor and a capacitor in series or in parallel, the parasitic resistances widen the circuit's passband or stopband. As a result, oscillator frequencies may become less precise and, in fact, less stable. RF systems, whether broadband or not, depend on stable oscillator frequencies. For example, in radar and GPS applications, uncertainty of an oscillator frequency may translate into an uncertainty of position. In radio and wireline applications, uncertainty of the oscillator frequency may result in loss of data transmission capacity. Thus, to have a stable oscillator frequency is easier in a narrowband application than in a broadband application. Yet, stable oscillator frequencies are also needed in broadband applications—for example, a radio that can receive only one station may be much less valuable than a radio that can receive a hundred or a thousand stations. Tunable devices were first designed over a century ago, and innovation continues today to include digitally configurable devices. An extensive overview is given in U.S. Pat. No. 9,197,194 by Reedy et al., “Methods and Apparatuses for Use in Tuning Reactance in a Circuit Device”. However, the devices disclosed by Reedy include switches in series with inductors, thereby increasing parasitic resistance.

A digitally-configurable inductor was disclosed in U.S. Pat. No. 7,460,001 by Jessie, “Variable Inductor for Integrated Circuit and Printed Circuit Board”, including a primary conductor and a tertiary conductor surrounding the primary conductor. However, its topology limits configurability.

### Terminology

As used herein, the phrase “one of” should be interpreted to mean exactly one of the listed items. For example, the phrase “one of A, B, and C” should be interpreted to mean any of: only A, only B, or only C.

As used herein, the phrases “at least one of” and “one or more of” should be interpreted to mean one or more items. For example, the phrase “at least one of A, B, and C” or the phrase “at least one of A, B, or C” should be interpreted to mean any combination of A, B, and/or C.

Unless otherwise specified, the use of ordinal adjectives “first”, “second”, “third”, etc., to describe an object, merely refers to different instances or classes of the object and does not imply any ranking or sequence.

The term “coupled” is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetical, or mechanical, between the things that are connected, without any intervening things or devices.

The term “configured to” perform a task or tasks is a broad recitation of structure generally meaning “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.”

The terms “substantially”, “close”, approximately”, “near”, and “about” refer to being within minus or plus 10% of an indicated value, unless explicitly specified otherwise.

The following terms or acronyms used herein are defined at least in part as follows:

Primary conductor loop—an inductor formed by an open conductor loop that may have multiple windings and that may occupy multiple interconnect layers. Its open ends are or include the inductor terminals. The primary conductor loop is uninterrupted by any switches.

Secondary conductor loop—a closed conductor loop interrupted by a digitally controlled loop switch. A secondary conductor loop is located inside and inductively coupled with a primary conductor loop. Two or more secondary conductor loops may be electrically coupled to each other via digitally controlled loop coupling switches. A secondary conductor loop may occupy multiple interconnect layers. A secondary conductor loop may have a configurable inductance, for example by including a configurable number of windings in the closed conductor loop. A secondary conductor loop may be electrically coupled with the primary conductor loop by a single bridge only.

Tertiary conductor loop—a closed conductor loop interrupted by a digitally controlled loop switch. The tertiary conductor loop is located at least partially outside a primary conductor loop, and is inductively coupled with the primary conductor loop. Two or more tertiary conductor loops may be coupled to each other via digitally controlled loop coupling switches. A tertiary conductor loop may occupy multiple interconnect layers. A tertiary conductor loop may have a configurable inductance, for example by including a configurable number of windings in the closed conductor loop. A tertiary conductor loop may be electrically coupled with the primary conductor loop by a single bridge only.

Quaternary conductor loop—a closed conductor loop interrupted by a digitally controlled loop switch. The quaternary conductor loop is at least partially located on one or more different interconnect layers than a primary conductor loop to which it is inductively coupled. Two or more quaternary conductor loops may be coupled to each other via digitally controlled loop coupling switches. A quaternary conductor loop may have a configurable inductance, for example by including a configurable number of windings in the closed conductor loop. A quaternary conductor loop may be electrically coupled with the primary conductor loop by a single bridge only.

FD-SOI—a fully depleted silicon-on-insulator technology that provides CMOS transistors with a planar transistor structure, fully depleted operation, and the ability to dynamically modify their threshold voltage.

GPS—Global Positioning System.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

PCB—printed circuit board

RF—“radio frequency” is a range of frequencies of electromagnetic signals used for transmission of radio waves, historically starting at around 20 kHz, and currently up to at least 300 GHz.

### Implementations

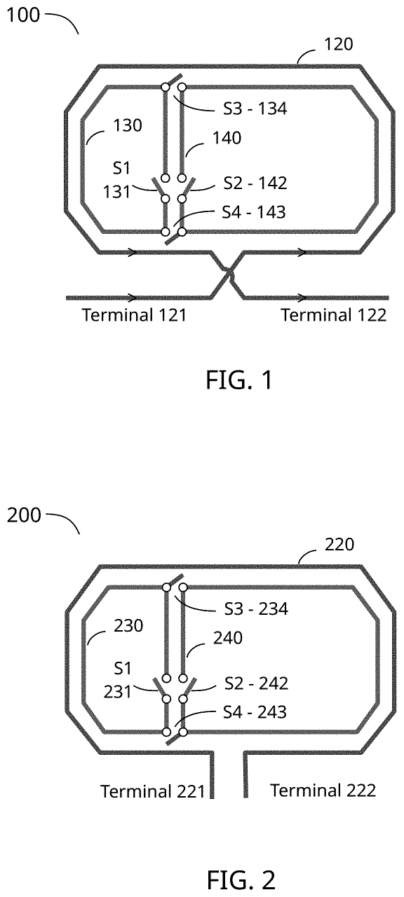

FIG. 1 illustrates a configurable inductor 100 in an implementation of the disclosed technology. Configurable inductor 100 includes a primary conductor loop 120 (drawn in red), electrically coupled to inductor terminal 121 and inductor terminal 122. Primary conductor loop 120 is uninterrupted by any switches to keep parasitic resistance low and enable a high Q-factor. Configurable inductor 100 also includes one or more secondary conductor loops (drawn in blue). Two have been drawn: first secondary conductor loop 130 and second secondary conductor loop 140. Primary conductor loop 120 is inductively coupled with first secondary conductor loop 130 and second secondary conductor loop 140. This is achieved by placing the secondary conductor loops inside primary conductor loop 120. Each secondary conductor loop is interrupted by a digitally controlled loop switch. This implementation shows digitally controlled loop switch 131 (switch S1) in first secondary conductor loop 130 and digitally controlled loop switch 142 (switch S2) in second secondary conductor loop 140. In open position, a digitally controlled loop switch renders a secondary conductor loop inoperative, and in closed position it renders it operative. When a switch is closed and the secondary conductor loop is operative, the induction of primary conductor loop 120 decreases.

Both primary conductor loop 120 and each or some of the secondary conductor loops may span multiple interconnect layers. ICs, PCBs, and other substrates typically include multiple layers of metal or other material(s) used to interconnect devices, i.e., to provide an electrical coupling between terminals of devices. However, inductors, just as capacitors, may be fabricated from structures in the interconnect layers. Thus, an inductor loop could use any or all of the available interconnect layers.

Configurable inductor 100 may further comprise digitally controlled loop coupling switches (drawn in green) that couple secondary conductor loops to each other to form a larger secondary conductor loop. For example, digitally controlled loop switch 131 and digitally controlled loop switch 142 may be left open so that first secondary conductor loop 130 and second secondary conductor loop 140 each by themselves are inoperative. But when an implementation closes digitally controlled loop coupling switch 134 and digitally controlled loop coupling switch 143, then first secondary conductor loop 130 and second secondary conductor loop 140 together form a new inductor of different form and inductance. The value of the new inductance depends on the placement of digitally controlled loop coupling switch 134 and digitally controlled loop coupling switch 143 and the lengths of any unused paths through digitally controlled loop switch 131 and digitally controlled loop switch 142. Generally, the digitally controlled loop coupling switches are located on both sides of the two digitally controlled loop switches, but their distance to the two digitally controlled loop switches determines the lengths of conductor wire that are unused when the two secondary control loops are coupled to each other.

FIG. 2 illustrates another configurable inductor 200 in an implementation of the disclosed technology. This implementation is similar to the configurable induction in FIG. 1, however, the connections between primary conductor loop 220 and its terminals inductor terminal 221 and inductor terminal 222 are not crossed. All elements in configurable inductor 200 have the same function and like lead numbers as configurable inductor 100 in FIG. 1.

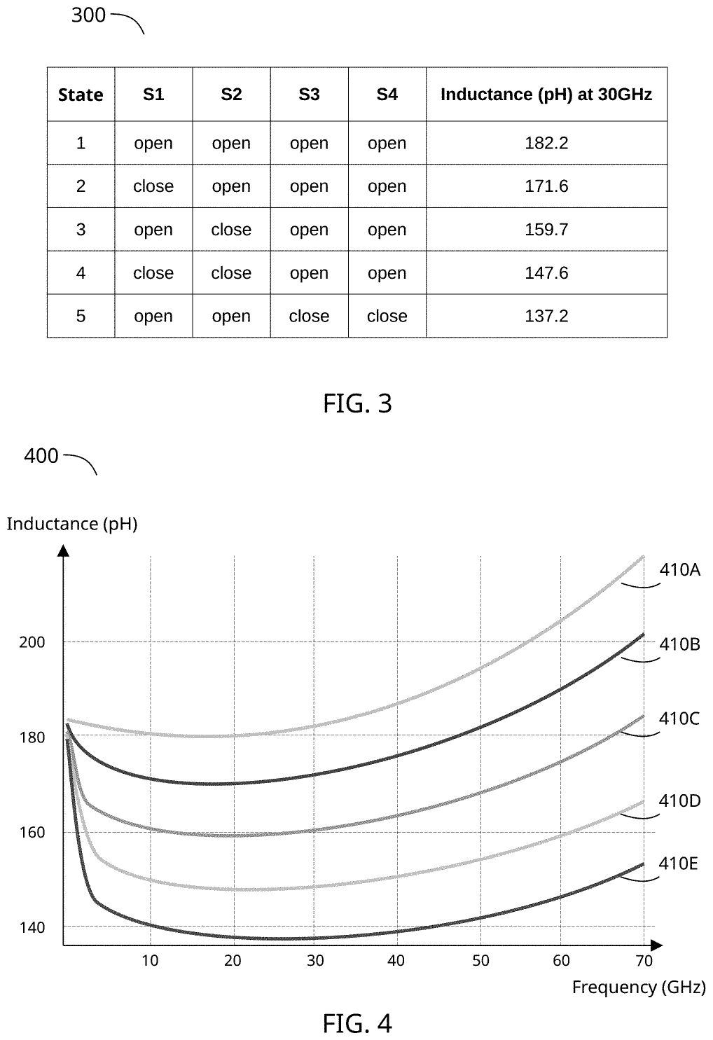

FIG. 3 provides a table 300 showing example inductance values achieved with different settings of the digitally controlled switches in FIG. 1. The inductances are in pico-Henry's at a frequency of 30 GHz. Because none of the switches is in primary conductor loop 120, configurable inductor 100 can achieve high-quality operation, and because there are multiple secondary conductor loops inside of primary conductor loop 120, the configurability is high, allowing for a relatively broad tuning range that could otherwise only be achieved by using multiple separate inductors. This would cost much more die area on an IC, or board area on a PCB or other substrate, and would be much more expensive.

FIG. 4 shows a chart 400 with inductance values 410A-E of the inductor in FIG. 1 as a function of the frequency. The inductance values 410 have been simulated with a three-dimensional electromagnetic simulator, based on the implementation of FIG. 1 in a modern FD-SOI CMOS process that is commercially popular for wireless RF applications.

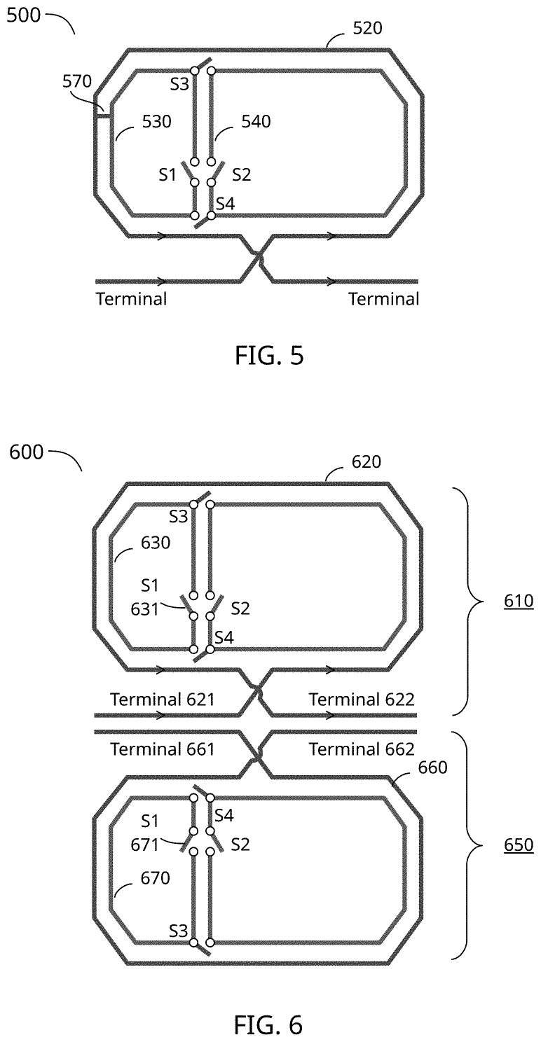

FIG. 5 illustrates another example configurable inductor 500. Whereas configurable inductor 100 in FIG. 1 has primary conductor loop 120 electrically insulated from first secondary conductor loop 130, configurable inductor 500 has primary conductor loop 520 electrically coupled to secondary conductor loop 530 at exactly one point, via conducting bridge 570. The location of conducting bridge 570 may vary, as convenient or useful in a design. Although primary conductor loop 520 has the connections to its terminals crossed, like configurable inductor 100 in FIG. 1, in another implementation the connections to the terminals are not crossed, like configurable inductor 200 in FIG. 2.

FIG. 6 illustrates an example configurable differential inductor 600. It includes instance 610 with primary conductor loop 620 and instance 650 with primary conductor loop 660, which may be instances of any of the configurable inductors disclosed or suggested in this document, arranged as mirror counterparts. Although the implementation drawn has the differential ports (terminal 621 and terminal 622 versus terminal 661 and terminal 662) on the inside of the arrangement, another implementation may have the differential ports on the outsides of the arrangement. Yet further implementations may have an arrangement of four instances of a configurable inductor, placed in a cross arrangement. Each of the instances of a configurable inductor in an arrangement has a set of digitally controlled loop switches, and may have additional digitally controlled loop coupling switches, jointly forming a set of switches S1, S2, etc. To maintain differential balance, associated switches in counterpart configurable inductors must be kept in the same state. For example, switch S1 (digitally controlled loop switch 631) in first secondary conductor loop 630 of instance 610 must be in the same state as switch S1 (digitally controlled loop switch 671) in first secondary conductor loop 670 of instance 650, etc. Although primary conductor loop 620 has the connections to its terminals (terminal 621 and terminal 622) crossed, and primary conductor loop 660 has the connections to its terminals (terminal 661 and terminal 662) crossed, like configurable inductor 100 in FIG. 1, in another implementation the connections to the terminals are not crossed, like configurable inductor 200 in FIG. 2.

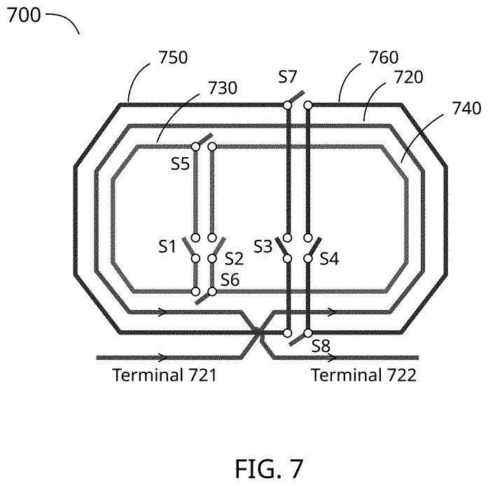

FIG. 7 illustrates an example configurable inductor 700 with primary, secondary and tertiary conductor loops. The primary conductor loop 720 is an open loop ending in inductor terminal 721 and inductor terminal 722. It does not need to be interrupted by any switches, so that it can maintain a high quality factor. In this example implementation there are two secondary conductor loops: first secondary conductor loop 730 with digitally controlled loop switch S1 and second secondary conductor loop 740 with digitally controlled loop switch S2. They may be combined with digitally controlled loop coupling switches S5 and S6. Also in this example implementation, there are two tertiary conductor loops (drawn in purple): first tertiary conductor loop 750 with digitally controlled loop switch S3 and second tertiary conductor loop 760 with digitally controlled loop switch S4. They may be combined with digitally controlled loop coupling switches S7 and S8. While the secondary conductor loops are placed inside primary conductor loop 720, the tertiary conductor loops are (fully or partially) placed outside primary conductor loop 720. Like secondary conductor loops, tertiary conductor loops are closed loops interrupted by digitally controlled loop switches. They may be combined using digitally controlled loop coupling switches. They may be electrically coupled to the primary conductor loop with a single bridge only (none has been drawn in FIG. 7). They may occupy any or all available interconnect layers. Although primary conductor loop 720 has the connections to its terminals (inductor terminal 721 and inductor terminal 722) crossed, like configurable inductor 100 in FIG. 1, in another implementation the connections to the terminals are not crossed, like configurable inductor 200 in FIG. 2.

Compared to configurable inductor 100 of FIG. 1, configurable inductor 700 of FIG. 7 offers four extra configurations (a total of nine), all with inductances smaller than those in table 300 of FIG. 3. While needing a little extra die area compared to conventional inductors, both implementations provide a large tuning range, with high resolution, and a high quality factor Q. Thus, they enable circuit designs with highly stable oscillators in broadband applications.

Whereas secondary conductor loops are placed inside a primary conductor loop, and tertiary conductor loops are placed outside a primary conductor loop, quaternary conductor loops may be placed over, under, and in between a primary conductor loop, occupying one or more interconnect layers that are not used by the primary conductor loop. A quaternary conductor loop may also be partially inside and partially outside the primary conductor loop. Other than their arrangement in relation to the primary conductor loop, quaternary conductor loops share all characteristics of secondary and tertiary conductor loops. They are closed loops interrupted by digitally controlled loop switches. They may be combined using digitally controlled loop coupling switches. They may be electrically coupled to the primary conductor loop with a single bridge only. They may occupy any or all available interconnect layers.

An implementation has a primary conductor loop with any combination of secondary, tertiary, and/or quaternary conductor loops. An implementation spanning several interconnect layers that has all of secondary, tertiary, and quaternary loops may be configurable in many states, and may therefore provide a high quality factor Q over a very wide tuning range without requiring a large die area (or PCB or substrate area).

### Considerations

Although the description has been described with respect to particular implementations thereof, these particular implementations are merely illustrative, and not restrictive. The description may reference specific structural implementations and methods, and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the present invention the nature of which is to be determined from the foregoing description.

Any suitable technology for manufacturing electronic devices can be used to implement the circuits of particular implementations, including CMOS, FinFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different particular implementations. In some particular implementations, multiple elements, devices, or circuits shown as sequential in this specification can be operating in parallel.

Particular implementations may be implemented by using application-specific integrated circuits, programmable logic devices, field-programmable gate arrays, optical, chemical, biological, quantum or nanoengineered systems, PCBs, thin-film circuits, thick-film circuits, etc. Other components and mechanisms may be used. In general, the functions of particular implementations can be achieved by any means as is known in the art.

It will also be appreciated that one or more of the elements depicted in the drawings/figures can also be implemented in a more separated or integrated manner, or even removed or rendered as inoperable in certain cases, as is useful in accordance with a particular application.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A configurable inductor, comprising:
a primary conductor loop including an open conductor loop ending in inductor terminals; and
one or more secondary conductor loops arranged at least partially inside the primary conductor loop, wherein:
each secondary conductor loop includes a closed conductor loop interrupted by a digitally controlled loop switch; and
each secondary conductor loop is inductively coupled with the primary conductor loop.

2. The configurable inductor of claim 1, wherein:
the primary conductor loop is uninterrupted by any switches.

3. The configurable inductor of claim 1, wherein:
a secondary conductor loop is electrically coupled with the primary conductor loop via a single bridge.

4. The configurable inductor of claim 1, wherein:
the primary conductor loop uses multiple interconnect layers.

5. The configurable inductor of claim 1, wherein:
at least one of the one or more secondary conductor loops uses multiple interconnect layers.

6. The configurable inductor of claim 1, wherein:
at least one of the one or more secondary conductor loops has a configurable inductance.

7. The configurable inductor of claim 1, wherein:
two secondary conductor loops are stacked above each other in different interconnect layers.

8. The configurable inductor of claim 1, further comprising:
two digitally controlled loop coupling switches between two secondary conductor loops enabling electric coupling of the two secondary conductor loops to form a combined secondary conductor loop.

9. The configurable inductor of claim 1, further comprising:
one or more tertiary conductor loops arranged at least partially outside the primary conductor loop, wherein:
each tertiary conductor loop includes a closed conductor loop interrupted by a digitally controlled loop switch; and
each tertiary conductor loop is inductively coupled with the primary conductor loop.

10. The configurable inductor of claim 9, further comprising:
two digitally controlled loop coupling switches between two tertiary conductor loops enabling electric coupling of the two tertiary conductor loops to form a combined tertiary conductor loop.

11. The configurable inductor of claim 9, wherein:
at least one of the one or more tertiary conductor loops uses multiple interconnect layers.

12. The configurable inductor of claim 9, wherein:
at least one of the one or more tertiary conductor loops has a configurable inductance.

13. The configurable inductor of claim 9, wherein:
two tertiary conductor loops are stacked above each other in different interconnect layers.

14. The configurable inductor of claim 1, further comprising:
one or more quaternary conductor loops arranged at least partially on a different layer of interconnect than the primary conductor loop, wherein:
each quaternary conductor loop includes a closed conductor loop interrupted by a digitally controlled loop switch; and
each quaternary conductor loop is inductively coupled with the primary conductor loop.

15. The configurable inductor of claim 14, further comprising:
two digitally controlled loop coupling switches between two quaternary conductor loops enabling electric coupling of the two quaternary conductor loops to form a combined quaternary conductor loop.

16. The configurable inductor of claim 14, wherein:
at least one of the one or more quaternary conductor loops has a configurable inductance.

17. The configurable inductor of claim 14, wherein:
two quaternary conductor loops are stacked above each other in different interconnect layers.

18. A configurable inductor, comprising:
a primary conductor loop including an open conductor loop ending in inductor terminals; and
one or more tertiary conductor loops arranged partially outside the primary conductor loop, wherein:
each tertiary conductor loop includes a closed conductor loop interrupted by a digitally controlled loop switch; and
each tertiary conductor loop is inductively coupled with the primary conductor loop.

19. The configurable inductor of claim 18, further comprising:
two digitally controlled loop coupling switches between two tertiary conductor loops enabling electric coupling of the two tertiary conductor loops to form a combined tertiary conductor loop.

20. A configurable inductor, comprising:
a primary conductor loop including an open conductor loop ending in inductor terminals; and
one or more quaternary conductor loops arranged at least partially on a different layer of interconnect than the primary conductor loop, wherein:
each quaternary conductor loop includes a closed conductor loop interrupted by a digitally controlled loop switch; and
each quaternary conductor loop is inductively coupled with the primary conductor loop.

21. The configurable inductor of claim 20, further comprising:
two digitally controlled loop coupling switches between two quaternary conductor loops enabling electric coupling of the two quaternary conductor loops to form a combined quaternary conductor loop.
